(19) United States
(12) Patent Application Publication
(10) Pub. No.: US 2014/0329982 A1
(43) Pub. Date: Nov. 6, 2014

(54) METHOD FOR PRODUCING PURIFIED NITRILE RUBBERS

(71) Applicant: LANXESS Deutschland GmbH, Cologne (DE)

(72) Inventors: Sven Brandau, Strasbourg (FR); Sarah David, Dormagen (DE); Florian Forner, Koeln (DE); Stefan Huesgen, Rommerskirchen (DE); Andreas Kaiser, Strasbourg (FR); Julia Maria Jeschko, Gilgenberg (AT); Peter Schwan, Leverkusen (DE)

(21) Appl. No.: 14/362,690

(22) PCT Filed: Dec. 11, 2012
(86) PCT No.: PCT/EP2012/075092

§ 371 Date: Jun. 4, 2014

(30) Foreign Application Priority Data
Dec. 29, 2011 (EP) 11196044.9

(51) Int. Cl. C08C 2/02; C08C 19/00; C08F 236/12

(52) U.S. Cl. CPC C08C 2/02; C08F 236/12; C08C 19/00
USPC 526/338

(57) ABSTRACT

A new process is provided for producing a purified nitrile rubber by subjecting the nitrile rubber, which contains specific impurities, to a defined ultrafiltration. Success is thereby achieved in substantially reducing the amount of the specific impurities in the nitrile rubber.

The present invention relates to a process for producing purified nitrile rubbers which feature a significantly reduced fraction of specific by-products, relative to the nitrile rubber used for the purification, and also relates to the purified nitrile rubbers obtainable by this process, to the use thereof for producing vulcanizates, and to these vulcanizates.

Nitrile rubbers, also abbreviated to “NBR”, are rubbers involving co- or terpolymers of at least one α,β-unsaturated nitrile, of at least one conjugated diene and optionally of one or more other copolymerizable monomers. Hydrogenated nitrile rubbers (“HNBR”) are corresponding co- or terpolymers in which the C═C double bonds of the copolymerized diene units have been fully or partially hydrogenated.

Both NBR and HNBR have for many years occupied a secure position in the sector of specialty elastomers. They have an excellent property profile in the form of excellent oil resistance, good heat resistance and outstanding resistance to ozone and chemicals, and this latter resistance is even higher for HNBR than for NBR. Furthermore, NBR and HNBR have very good mechanical and also performance characteristics. They are therefore widely used in a very wide variety of application sectors, and by way of example are used for producing gaskets, hoses, drive belts and damping elements in the automotive sector, and also for stators, borehole seals and valve seals in the oil-production sector, and also for numerous components in the electrical industry, and in mechanical engineering and shipbuilding. There is a wide variety of commercially available types, and these feature different monomers, molar masses, polydispersities, and mechanical and physical properties, as a function of application sector. In particular, there is increasing demand not only for the standard types but also in particular for specialty types comprising specific termonomer contents or particular functionalizations.

Industrial production of nitrile rubbers has to date been almost exclusively through what is known as emulsion polymerization. This process often uses dodecyl mercaptans, in particular tertiary dodecyl mercaptans (abbreviated to “TDDM” or else “TDM”), to regulate molar mass and thus also to regulate the viscosity of the resultant nitrile rubber. After polymerization, the resultant NBR latex is coagulated in a first step, and the solid NBR is isolated therefrom. For certain applications it is desired to reduce the molecular weight of these nitrile rubbers in a controlled way by means of a subsequent metathesis reaction and/or to prepare the corresponding hydrogenated nitrile rubber from these nitrile rubbers by hydrogenation. The metathesis takes place using specific metathesis-active metal complex catalysts, and the hydrogenation can be carried out, for example, with use of homogeneous or else heterogeneous hydrogenation catalysts. The hydrogenation catalysts are usually based on rhodium, ruthenium or titanium. However, it is also possible to use platinum, iridium, palladium, rhenium, ruthenium, osmium, cobalt or copper either as metal or else preferably in the form of metal compounds.

Not only for specific applications in the injection-moulded articles segment, applications involving food contact, the medical sector, the electronics industry, but also for further reactions such as hydrogenations in the presence of sensitive transition-metal catalysts, there is a need for particularly pure nitrile rubbers. The nitrile rubbers produced to date by emulsion polymerization must therefore frequently be freed, in a costly and inconvenient procedure, from the extraneous substances arising from the production operation. For nitrile rubbers with too great a fraction of extraneous substances, their usefulness, particularly in a medical environment and in food contact applications, is usually greatly restricted on toxicological grounds, the tolerable amount of extraneous substances being dependent on the nature of the extraneous substance. In the case of nitrile rubbers produced by free-radical emulsion polymerization, extraneous substance fractions of well below 2% by weight are preferred in the aforementioned applications. The use of mouldings made from nitrile rubbers having too great an extraneous substance fraction in electronic applications is likewise of only limited possibility. This is especially so when the rubbers comprise water and/or ions as extraneous substances, since such substances may greatly affect the corrosion properties and conductivity properties of the electronic products and, as a result of thermal influences, may not always be removed without residue. In many applications, furthermore, such as in the case of injection-moulded articles or extruded articles, the use of nitrile rubbers having a relatively large extraneous substance fraction (greater than 3% by weight) may lead to a reduced surface quality on the articles and also to mould fouling or efflorescence. Nitrile rubbers having an extraneous substance fraction of greater than 4% by weight, based on the nitrile rubber, can often not be used for reactions such as metatheses and/or hydrogenations which are necessarily operated in the presence of sensitive transition metal catalysts, since the extraneous substances hinder reaction monitoring, prolong conversion times, and reduce the catalyst efficiency. In the case of hydrogenation, furthermore, the extraneous substances may contribute critically to the corrosion and hence to the wear of the equipment needed for the hydrogenation. There is often also an economic interest in recovering the extraneous substances that have remained in the nitrile rubber. This is particularly the case when expensive catalysts have been used which can be used again for catalysis after being worked up.

Purification of the nitrile rubbers to remove extraneous substances, for the applications identified above, is typically accomplished by means of precipitating and washing operations, using water or suitable organic substances such as alcohols, ketones, ethers or mixtures thereof. In such cases, however, it is not possible fundamentally to ensure complete purification. A particular problem with the nitrile rubbers produced to date by free-radical emulsion polymerization has been the removal of low-molar-mass extraneous substances, some of them high-boiling (>150° C.), which have little or no water-solubility. These include, for example, emulsifiers, fatty acids, fatty acid salts and fatty acid esters from the emulsion polymerization of the nitrile rubber. For a long time, the work-up and purification methods known in the art have been unable to remove these extraneous substances adequately, and, if so, then only with a considerable economic expense, since during latex coagulation these substances are enveloped by the nitrile rubber and so are impossible or difficult for the washing procedures to access. Fractional precipitation of the nitrile rubbers from solution is a possibility for the removal of compounds of low molar mass. It employs suitable organic solvents as precipitants, in which the polymer is insoluble (e.g. methanol), while certain extraneous substances, such as the emulsifiers, fatty acids, fatty acid esters and fatty acid salts, for example, remain in solution. This work-up, however, is deleterious environmentally and economically, owing to the lame amounts of solvent and/or precipitant required.

EP-A-1 524 277 discloses a method for purifying elastomers and especially nitrile rubbers that uses ultrafiltration to work up elastomers prepared by free-radical emulsion polymerization. The method claims removal of up to 99% of the extraneous substances and by-products originating from the emulsion polymerization, particularly the emulsifiers, which are used in large amounts in the polymerization. In both of the examples of EP-A-1 524 277, the removal is shown of fatty acids from a nitrile rubber and from a hydrogenated nitrile rubber, respectively, in solution in monochlorobenzene as organic solvent.

Described for the first time in WO-A-2011/032832 was a method for producing nitrile rubbers which allowed nitrile rubbers with sufficiently high average molar masses Mₙ to be obtained by polymerization in organic solution within economically acceptable reaction times. That method is operated in the presence of specific chain transfer agents referred to as RAFT regulators. The fact that the use of these RAFT regulators was successful in the context of NBR polymerization was surprising, particularly against the background of earlier studies into the preparation of polybutadiene in organic solution (Maeromolecular Chemistry and Physics (2002), 203(3), 522-537), which had only produced molar masses in orders of magnitude of no industrial interest (industrially utilizable polymers based on butadiene generally require a molar mass Mₙ>50 000 g/mol, the same applying to random copolymers based on acrylonitrile and butadiene). According to WO 2012/028501 A and also WO 2012/028503 A, nitrile rubbers can be prepared by polymerization in organic solution even in the absence of any molar-mass regulators or in the presence of specific regulators, such as mercaptans, mercapto alcohols, mercaptocarboxylic acids, thiocarboxylic acids, disulphides, polysulphides and thiourea, for example. A feature common to all of these polymerization methods in organic solution is that there is no need to use any emulsifiers to implement them, meaning that the resultant nitrile rubbers and their downstream products, such as hydrogenated nitrile rubbers, for example, need not, accordingly, be freed from these emulsifiers. However, the polymerization method in organic solution is often carried out at higher temperatures than the aqueous, free-radical emulsion polymerization. This means that by-products are formed that are observed only to a very low extent in the case of the aqueous free-radical emulsion polymerization. It is possible, for example, for by-products to be produced which are formed by a Diels-Alder reaction of the monomers used (referred to hereinafter in this patent specification as “Diels-Alder by-products”). These “Diels-Alder by-products” include not only by-products formed by Diels-Alder reaction of two molecules of the same monomer but also those formed by Diels-Alder reaction of two molecules of different monomers. This means, for example, that in the case of a butadiene-acrylonitrile copolymer, 4-vinylcyclohexene (“VCH”) and 4-cyanocyclohexene (“CCH”) may be formed as Diels-Alder by-products. VCH is formed by Diels-Alder reaction from two molecules of 1,3-butadiene, CCH by Diels-Alder reaction from 1,3-butadiene and acrylonitrile. The presence of these Diels-Alder by-products may have deleterious consequences in certain applications and also in downstream reactions such as metathesis or hydrogenation reactions, and is therefore undesirable. A method for removing these Diels-Alder by-products has so far not been described in the literature.

The object of the present invention was therefore to provide a process for purifying nitrile rubbers containing Diels-Alder by-products, allowing the fraction of the Diels-Alder by-products in the nitrile rubber to be reduced so significantly and in controlled form that applications where particular purity is important, and also downstream reactions such as metathesis and hydrogenation, are not adversely affected.

This object is achieved by means of a process for producing a purified nitrile rubber, which is characterized in that a nitrile rubber which has repeat units of at least one conjugated diene monomer and of at least one α,β-unsaturated nitrile monomer and also comprises Diels-Alder by-products of these monomers is subjected to an ultrafiltration, by the nitrile rubber, in solution in at least one organic solvent, being passed one or more times over an ultrafiltration membrane, to give a retentate stream which comprises the purified nitrile rubber and does not flow through the ultrafiltration membrane, and a permeate stream which comprises Diels-Alder by-products and which flows through the ultrafiltration membrane, with the provisos that
(i) the ultrafiltration membrane has one or more porous layers and the layer with the smallest pores possesses a pore diameter in the 1-200 nm range,
(ii) the ultrafiltration is carried out at a temperature in the range from 10 to 150° C. with application of a pressure in the range from 1 to 80 bar, and
(iii) the flow rate of the retentate stream during the ultrafiltration is set to a level of greater than 0.2 m/sec, and
   the amount of Diels-Alder by-products in the purified nitrile rubber is reduced by at least 50% by weight as a result of the ultrafiltration, relative to the amount in the nitrile rubber originally used.

The fact that the ultrafiltration of the invention is able successfully to remove the neither ionically charged nor significantly polar Diels-Alder by-products from the nitrile rubber was unforeseeable, particularly in light of the fact that the substances which according to EP-A-1 524 277 can be removed from nitrile rubbers, such as emulsifiers, fatty acids, fatty acid salts and fatty acid esters, are ionic and/or significantly polar.

A further subject of the invention is the purified nitrile rubber obtainable by the ultrafiltration of the invention.

A further subject of the invention is the production of vulcanizates by subjecting the purified nitrile rubber to a vulcanization.

A further subject of the invention are the vulcanizates based on the purified nitrile rubbers.

Amount of Impurities Before and after the Process of the Invention:

As a result of the ultrafiltration according to the invention it is possible to take unpurified nitrile rubbers having repeat units of at least one conjugated diene monomer and at least one α,β-unsaturated nitrile monomer and to prepare, from them, corresponding, purified nitrile rubbers which have a Diels-Alder by-products content which is reduced by at least 50% by weight relative to the original, unpurified state. Nitrile rubbers purified by the process of the invention are obtained preferably with a Diels-Alder by-products content which has been reduced by at least 80% by weight based on the amount in the nitrile rubber originally used.

With particular preference, nitrile rubbers purified by the process of the invention are obtained with a Diels-Alder by-products content which has been reduced by at least 90% by weight and up to 99.9% by weight, based on the amount in the nitrile rubber originally used.

Unpurified nitrite rubbers used in the process of the invention are typically nitrile rubbers which have a Diels-Alder by-products content in the monomers in the range from 0.1 to 120% by weight, based on 100% by weight of the nitrile rubber.

By the “purified nitrite rubbers” in the context of this specification are meant those nitrile rubbers for which the amount of Diels-Alder by-products in the monomers has been reduced by at least 50% by weight, preferably by at least 80% by weight and more preferably by at least 90% by weight and up to 99.9% by weight, based on the amount in the nitrile rubber originally used.

Starting from an unpurified nitrite rubber having an amount of Diels-Alder by-products in the monomers of, for example, 10% by weight based on 100% by weight of the nitrile rubber, it is therefore possible, with at least 50% reduction, to obtain a purified nitrile rubber having an amount of Diels-Alder by-products in the monomers of 5% by weight or less, based on 100% by weight of the nitrite rubber. In the case of the use, for example, of an unpurified nitrile rubber having the aforementioned amount of 10% by weight of Diels-Alder by-products, based on 100% by weight of the nitrile rubber, the process of the invention can therefore be used preferably to obtain a purified nitrile rubber which then has only an amount of Diels-Alder by-products in the range from 0.1% by weight (corresponding to a 99.9% by weight removal) up to a maximum of 1% by weight (corresponding to a 90% by weight removal), based on 100% by weight of the nitrile rubber.

A feature of the process of the invention is that this relative purification of a nitrite rubber that is used is accomplished independently of the absolute degree of contamination of the nitrile rubber used.

Advantageously, the process of the invention allows not only the removal of the Diels-Alder by-products, but also the removal of other substances. Through the process of the invention it is also possible, for example, to remove substances selected from the group consisting of unreacted monomers, unreacted initiator, initiator decomposition products, polymerization terminators, stabilizers used as antioxidants, molar-mass regulators, and fragments or decomposition products of these molar-mass regulators, and of oligomeric constituents.

Nitrile Rubbers which can be Used:

The nitrile rubbers used in the process of the invention have repeat units of at least one conjugated diene and at least one α,β-unsaturated nitrile and include Diels-Alder by-products of these monomers; optionally, the nitrile rubber may also, additionally, have repeat units of one or more copolymerizable termonomers. These nitrile rubbers containing Diels-Alder by-products are typically prepared by free-radical polymerization in at least one organic solvent.

The conjugated diene monomer in the nitrile rubber can be of any type. It is preferable to use (C₄-C₆) conjugated dienes. Particular preference is given to 1,2-butadiene, 1,3-butadiene, isoprene, 2,3-dimethylbutadiene, piperylene, and mixtures thereof. In particular, 1,3-butadiene and isoprene and mixtures thereof are preferred. 1,3-Butadiene is very particularly preferred.

α,β-Unsaturated nitrile monomer used can comprise any known α,β-unsaturated nitrile, preference being given to (C₃-C₅)-α,β-unsaturated nitriles such as acrylonitrile, methacrylonitrile, ethacrylonitrile and mixtures thereof. Acrylonitrile is particularly preferred.

One nitrile rubber preferred for use in the process of the invention is a copolymer of acrylonitrile and 1,3-butadiene.

The nitrile rubber for use in the process of the invention may optionally have repeat units of one or more other copolymerizable termonomers, by way of example aromatic vinyl monomers, preferably styrene, α-methylstyrene and vinylpyridine, fluorinated vinyl monomers, preferably fluoroethyl vinyl ether, fluoropropyl vinyl ether, o-fluoromethylstyrene, vinyl pentafluorobenzoate, difluoroethylene and tetrafluoroethylene, or else copolymerizable anti-ageing monomers, preferably N-(4-anilinophenyl)acrylamide, N-(4-anilinophenyl)methacrylamide, N-(4-anilinophenyl)cinnamide, N-(4-anilinophenyl)crotonamide, N-phenyl-4-(3-vinylbenzyloxy)aniline and N-phenyl-4-(4-vinylbenzyloxy)aniline, and also alkynes, such as 1- or 2-butyne.

As an alternative, the nitrile rubber for inventive use may also comprise repeat units of carboxyl-containing copolymerizable termonomers, for example α,β-unsaturated monocarboxylic acids, their esters, their amides, α,β-unsaturated dicarboxylic acids, their mono- or diesters or their corresponding anhydrides or amides.

α,β-Unsaturated monocarboxylic acids that are suitable preferably comprise acrylic acid and methacrylic acid.

It is also possible to use esters of the α,β-unsaturated monocarboxylic acids, preferably their alkyl esters and alkoxyalkyl esters. Preference is given to the alkyl esters, in particular C₁-C₁₈ alkyl esters, of the α,β-unsaturated monocarboxylic acids. Particular preference is given to alkyl esters, in particular C₁-C₁₈ alkyl esters, of acrylic acid or of methacrylic acid, in particular methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, particularly alkoxyalkyl esters of acrylic acid or of methacrylic acid, in particular C₂-C₁₂-alkoxyalkyl esters of acrylic acid or of methacrylic acid, very particularly methoxymethyl acrylate, methoxyethyl (meth)acrylate, ethoxyethyl (meth)acrylate and methoxymethyl (meth)acrylate. It is also possible to use mixtures of alkyl esters, e.g. of those mentioned above, with alkoxyalkyl esters, e.g. in the form of those mentioned above. It is also possible to use cyanoalkyl acrylates and cyanoalkyl methacrylates in which the number of carbon atoms in the cyanoalkyl group is from 2 to 12, preferably α-cyanoethyl acrylate, β-cyanoethyl acrylate and cyanobutyl methacrylate. It is also possible to use hydroxyalkyl acrylates and hydroxyalkyl methacrylates in which the number of carbon atoms in the hydroxyalkyl groups is from 1 to 12, preferably 2-hydroxyethyl acrylate, 2-hydroxyethyl methacrylate and 3-hydroxypropyl acrylate. It is also possible to use fluorine-substituted benzyl-containing acrylates or methacrylates, preferably fluorobenzyl acrylates, and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Other copolymerizable monomers that can be used also comprise α,β-unsaturated dicarboxylic acids, preferably maleic acid, fumaric acid, crotonic acid, itaconic acid, citraconic acid and mesaconic acid.

It is also possible to use α,β-unsaturated dicarboxylic anhydrides, preferably maleic anhydride, itaconic anhydride, citraconic anhydride and mesaconic anhydride.

It is also possible to use mono- or diesters of α,β-unsaturated dicarboxylic acids.

The said α,β-unsaturated dicarboxylic mono- or diesters can by way of example involve alkyl, preferably C₁-C₁₀-alkyl, in particular ethyl, n-propyl, isopropyl, n-butyl, tert-butyl, n-pentyl or n-hexyl, alkoxyalkyl, preferably C₂-C₁₂-alkoxyalkyl, particularly preferably C₃-C₈-alkoxyalkyl, hydroxyalkyl, preferably C₁-C₁₂-hydroxyalkyl, particularly preferably C₂-C₈-hydroxyalkyl, epoxyalkyl, preferably C₃-C₁₂-epoxyalkyl, cycloalkyl, preferably C₅-C₁₂cycloalkyl, particularly preferably C₆-C₁₂cycloalkyl, alkylcycloalkyl, preferably C₆-C₁₂alkylcycloalkyl, particularly preferably C₇-C₁₀alkylcycloalkyl, aryl, preferably C₆-C₁₄-aryl, mono- or diesters, where the diesters can respectively also involve mixed esters.

Particularly preferred alkyl esters of α,β-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propylheptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxymethyl (meth)acrylate. More particularly, methoxyethyl acrylate is used.

Particularly preferred hydroxyalkyl esters of the α,β-unsaturated monocarboxylic acids are hydroxyethyl (meth)acrylate, hydroxypropyl (meth)acrylate and hydroxybutyl (meth)acrylate.

Particularly preferred epoxyalkyl esters of the α,β-unsaturated monocarboxylic acids are 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidylmethyl acrylate, glycidylmethyl methacrylate, glycidyl acrylate, 3′,4′-epoxyheptyl 2-ethylacrylate, 3′,4′-epoxyheptyl 2-ethylmethacrylate, 6′,7″-epoxyheptyl acrylate, 6′,7″-epoxyheptyl methacrylate.

Other esters of α,β-unsaturated monocarboxylic acids also used comprise by way of example polyethylene glycol (meth)acrylate, polypropylene glycol (meth)acrylate, N-(2-hydroxyethyl)acrylamide, N-(2-hydroxymethyl)acrylamide and urethane (meth)acrylate.

Examples of α,β-unsaturated dicarboxylic monoesters comprise
maleic acid monoalkyl esters, preferably monomethyl maleate, monoethyl maleate, monopropyl maleate and mono-n-butyl maleate;
maleic acid monocycloalkyl esters, preferably monocyclopentyl maleate, monocyclohexyl maleate and monocycloheptyl maleate;
maleic acid monoalkyl cycloalkyl esters, preferably monomethyl cyclopentyl maleate and monoethyl cyclohexyl maleate;
maleic acid monoaryl esters, preferably monophenyl maleate;
maleic acid monobenzyl esters, preferably monobenzyl maleate;
fumaric acid monoalkyl esters, preferably monomethyl fumarate, monoethyl fumarate, monopropyl fumarate and mono-n-butyl fumarate;
fumaric acid monocycloalkyl esters, preferably monocyclopentyl fumarate, monocyclohexyl fumarate and monocycloheptyl fumarate;
fumaric acid monoalkyl cycloalkyl esters, preferably monomethyl cyclopentyl fumarate and monoethyl cyclohexyl fumarate;
fumaric acid monoaryl esters, preferably monophenyl fumarate;
fumaric acid monobenzyl esters, preferably monobenzyl fumarate;
citraconic acid monoalkyl esters, preferably monomethyl citraconate, monoethyl citraconate, monopropyl citraconate and mono-n-butyl citraconate;
citraconic acid monocycloalkyl esters, preferably monocyclopentyl citraconate, monocyclohexyl citraconate and monocycloheptyl citraconate;
citraconic acid monoalkyl cycloalkyl esters, preferably monomethyl cyclopentyl citraconate and monoethyl cyclohexyl citraconate;
citraconic acid monoaryl esters, preferably monophenyl citraconate;
citraconic acid monobenzyl esters, preferably monobenzyl citraconate;
itaconic acid monoalkyl esters, preferably monomethyl itaconate, monoethyl itaconate, monopropyl itaconate and mono-n-butyl itaconate;
itaconic acid monocycloalkyl esters, preferably monocyclopentyl itaconate, monocyclohexyl itaconate and monocycloheptyl itaconate;
itaconic acid monoalkyl cycloalkyl esters, preferably monomethyl cyclopentyl itaconate and monoethyl cyclohexyl itaconate;
itaconic acid monoaryl esters, preferably monophenyl itaconate;
itaconic acid monobenzyl esters, preferably monobenzyl itaconate.
mesaconic acid monoalkyl esters, preferably mesaconic acid monoethyl esters.

α,β-Unsaturated dicarboxylic diesters that can be used comprise the analogous diesters based on the monoester groups previously specified, where the ester groups can also involve chemically different groups.

It is moreover possible that other copolymerizable monomers used comprise compounds that can be polymerized by a free-radical route and which, per molecule, comprise two or more olefinic double bonds. Examples of these di- or polyunsaturated compounds are di- or polyunsaturated acrylates, methacrylates or itaconates of polyols, for example 1,6-hexanediol diacrylate (HDODA), 1,6-hexanediol dimethacrylate, ethylene glycol diacrylate, ethylene glycol dimethacrylate (EGDMA), diethylene glycol dimethacrylate, triethylene glycol diacrylate, butane-1,4-diol diacrylate, propane-1,2-diol diacrylate, butane-1,3-diol dimethacrylate, neopentyl glycol diacrylate, trimethylolpropane diacrylate, trimethylolpropane dimethacrylate, trimethylolethane diacrylate, trimethylolethane dimethacrylate, trimethylolpropane triacrylate, trimethylolpropane trimethacrylate (TMPTMA), glyceryl diacrylate and triacrylate, pentaerythritol di-, tri- and tetraacrylate or methacrylate, dipentaerythritol tetra-, penta- and hexaacrylate or methacrylate or itaconate, sorbitol tetraacrylate, sorbitol hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes having terminal hydroxy groups. Polyunsaturated monomers used can also comprise acrylamides, e.g. methylenebisacrylamide, hexamethylene-1,6-bisacrylamide, diethylenetriaminetrismethacrylamide, bis(methacrylamido-propoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate and triallyl phosphate.

The content of the at least one conjugated diene monomer and of the at least one α,β-unsaturated nitrile monomer in the nitrile rubber can vary widely. The content of the conjugated diene or of the entirety of the conjugated dienes is usually in the range from 40 to 90% by weight, preferably in the range from 50 to 85% by weight, based on the entire polymer. The content of the α,β-unsaturated nitrile or of the entirety of the α,β-unsaturated nitriles is usually from 10 to 60% by weight, preferably from 15 to 50% by weight, based on the entire polymer. The total content of the monomers is always 100% by weight. The amounts present of the additional monomers can be from 0 to 40% by weight, based on the entire polymer, depending on the nature of the termonomer(s). In this case, the content of the additional monomers replaces corresponding content of the conjugated diene(s) and/or of the α,β-unsaturated nitrile(s), where the total content of all of the monomers is always 100% by weight.

To the extent that the termonomers involve monomers which form tertiary free radicals (e.g. methacrylic acid), it has proved successful to use amounts of from 0 to 10% by weight of these.

It should be noted that the restriction previously specified of at most 40% for the additional monomers applies only in the scenario where the total amount of monomers is metered into the polymerization mixture at the start of or during the reaction (i.e. to produce random terpolymer systems). In the case of polymerization variant (1), outlined below, it is of course possible to employ an inventively prepared nitrile rubber as a macro-regulator, because it possesses, in the main polymer chain and/or in the terminal groups, fragments of the regulator(s) used, and to use it, for example, to generate block systems, by reaction with suitable monomers in any desired amount.

The glass transition temperatures of the unpurified nitrile rubbers used and also of their purified counterparts are typically in the range from −70° C. to +20° C., preferably in the range from −60° C. to 10° C.

The nitrile rubbers which can be used in the process according to the invention typically possess a polydispersity index in the range from 1.1 to 6.0, preferably in the range from 1.3 to 5.0, particularly preferably in the range from 1.4 to 4.5. In the case of variant embodiment (1) it is possible, by virtue of the living character of the polymerization process, to obtain nitrile rubbers with narrow molar mass distribution. It is then possible to produce nitrile rubbers with a polydispersity index in the range from 1.1 to 2.5, preferably in the range from 1.3 to 2.4, particularly preferably in the range from 1.4 to 2.2, in particular in the range from 1.5 to 2.0, very particularly preferably in the range from 1.5 to less than 2.

Polymerization to Give the Nitrile Rubber Containing Diels-Alder by-Products:

Solvent:

The nitrile rubbers used in the process of the invention are typically prepared by free-radical polymerization of the corresponding monomers in at least one organic solvent. Large amounts of water, as in the case of emulsion polymerization, are not present in the reaction system. Small amounts of water, in the order of magnitude of up to 5% by weight, preferably up to 1% by weight (based on the amount of the organic solvent), may well be present during the polymerization. The critical factor is that the amounts of water present must be minimized such that there is no precipitation of the nitrile rubber which forms. It should be made clear at this point that the polymerization in solution is not an emulsion polymerization.

Examples of suitable organic solvents include dimethylacetamide, monochlorobenzene, toluene, ethyl acetate, 1,4-dioxane, t-butanol, isobutyronitrile, 3-propanone, dimethyl carbonate, 4-methylbutan-2-one, acetone, acetonitrile and methyl ethyl ketone. Preference is given to polar solvents which have a Hildebrand dissolution parameter δ (δ=((ΔH_{V}−RT)/Vₘ)^{1/2}[(MPa)^{1/2}]) (Vₘ=molar volume; ΔH_{V}=vaporization enthalpy; R=ideal gas constant) in a range between 15.5 and 26 (MPa)^{1/2}. It is not possible to use solvents which intervene as transfer reagents in the reaction, examples being carbon tetrachloride, thiols, and other solvents of this kind known per se to the skilled person. It is likewise possible to use a mixture of two or more organic solvents. It is also possible to employ solvents which satisfy the above requirements and possess a boiling point which is below that of acrylonitrile, such as methyl tert-butyl ether (MTBE), for example.

Addition of Regulators:

The free-radical polymerization in solution for producing the nitrile rubbers used in the process of the invention can be carried out in a variety of embodiments,

(1) in the presence of a compound of the general structural formula (VI)

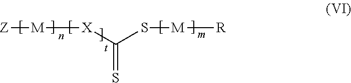

in which
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, silyloxy, nitrile, carbonyl, carboxy, oxycarbonyl, oxysulphonyl, oxo, thioxo, borates, selenates, epoxy, cyanates, thiocyanates, isocyanates, thioisocyanates and isocyanides,
R (a) if m≠0, has the same meanings as the moiety Z and
   (b) if m=0, is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, polycarbonates, polyurethanes, polyisocyanates, polysaccharides, polyesters and polyamides,
n and m are identical or different and are respectively in the range from 0 to 10 000,
t is 0 or 1, insofar as n 0, and is 1 insofar as n 0, and
X is C(Z₂), N(Z), P(Z), P(═O)(Z), O, S, S(═O) or S(═O)₂, where Z in these moieties can have the meanings stated previously for the formula (VI),
   or
   (2) in the presence of a compound selected from the group consisting of
(i) mercaptans which comprise at least one SH group,
(ii) mercapto alcohols which comprise at least one SH group and at least one OH group,
(iii) mercaptocarboxylic acids which comprise at least one SH group and at least one carboxy group, and mercaptocarboxylic esters which comprise at least one SH group and at least one carboxylic ester group,
(iv) thiocarboxylic acids,
(v) disulphides, polysulphides,
(vi) thiourea,
(vii) allyl compounds,
(viii) aldehydes,
(ix) aliphatic halohydrocarbons, araliphatic halohydrocarbons and
(x) saccharin and
(xi) any desired mixtures of two or more of the abovementioned molar-mass regulators (i)-(x),
   or
   (3) in the absence of the molar-mass regulators recited in sections (1) and (2)(i) to (xi).

Embodiment (1) of the Free-Radical Polymerization in Solution:

In the embodiment (1) which is subject matter of WO-A-2011/032832, at least one molar-mass regulator (“regulator”) or chain-transfer agent of the general formula (VI) is used. The meanings specified for the moieties Z and R of the general formula (VI) can respectively have mono- or polysubstitution. It is preferable that the following moieties have mono- or polysubstitution: alkyl, carbocyclyl, heterocyclyl, aryl, heteroaryl, arylalkyl, heteroarylalkyl, alkoxy, aryloxy, alkylthio, arylthio, amino, amido, carbamoyl, phosphonato, phosphinato, sulphanyl, thiocarboxy; sulphinyl, sulphono, sulphino, sulpheno, sulphamoyl, silyl, silyloxy, carbonyl, carboxy, oxycarbonyl, oxysulphonyl, oxo, thioxo, borates, selenates and epoxy.

Substituents that can in turn be used—to the extent that the results are chemically stable compounds—are any of the meanings that Z can assume. Particularly suitable substituents are halogen, preferably fluorine, chlorine, bromine or iodine, nitrile (CN) and carboxy.

The meanings specified for Z and R in the general formula (VI) also explicitly include salts of the moieties specified, to the extent that these are chemically possible and stable. Those involved here can by way of example be ammonium salts, alkali metal salts, alkaline earth metal salts, aluminium salts or protonated forms of the regulators of the general formula (VI).

The meanings specified for Z and R in the general formula (VI) also include organometallic moieties, for example those which provide a Grignard function to the regulator. Z and R can moreover be, or comprise, a carbanion, with lithium, zinc, tin, aluminium, lead and boron as counterion.

It is moreover possible that the regulator has coupling by way of the moiety R via a linker to a solid phase or support substance. The linker can involve one of the following linkers known to the person skilled in the art: Wang, Sasrin, or Rink acid, or 2-chlorotrityl, Mannich, safety-catch, traceless or photolabile linkers. Examples of solid phases or support substances that can be used are silica, ion-exchanger resins, clays, montmorillonite, crosslinked polystyrene, polyethylene glycol grafted onto polystyrene, polyacrylamides (“Pepsyn”), polyethylene glycol-acrylamide copoly (PEGA), cellulose, cotton and granulated porous glass (CPG, controlled pore glass).

It is moreover possible that the regulators of the general formula (VI) function as ligands for organometallic complex compounds, for example for those based on the following central metals: rhodium, ruthenium, titanium, platinum, iridium, palladium, rhenium, osmium, cobalt, iron or copper.

The meanings listed for the moiety “M” in the abovementioned general formula (VI) can have mono- or polysubstitution. M can therefore involve repeat units of one or more, mono- or polyunsaturated monomers, and preferably optionally can involve mono- or polysubstituted conjugated or non-conjugated dienes, or optionally mono- or polysubstituted alkynes or optionally mono- or polysubstituted vinyl compounds, for example fluorinated mono- or polyunsaturated vinyl compounds, or else can involve a divalent structural element which derives from substituted or unsubstituted polymers comprising poly-ethers, in particular polyalkylene glycol ethers and polyalkylene oxides, polysiloxanes, polyols, polycarbonates, polyurethanes, polyisocyanates, polysaccharides, polyesters and polyamides. Behind these moieties “M” there may therefore lie a monomeric or polymeric moiety.

It is preferable to use a regulator of the general formula (VI) in which

Z and R have the meanings previously specified for the general formula (VI) and
n, m and t are all equal to zero.

The said preferred regulator therefore has the general structure (VIa):

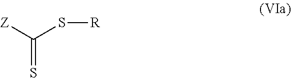

in which the moieties Z and R can have all of the meanings previously specified for the general formula (VI).

Trithiocarbonates:

Another preferred regulator that can be used comprises a regulator of the general formula (VIb),

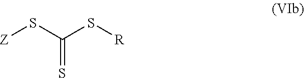

in which
Z has the meanings previously specified for the general formula (VI),
R has the meanings previously specified for the general formula (VI) for the variant b) where m=0 but with the restriction that, after homolytic cleavage of the S—R bond, R forms either a secondary, tertiary or aromatically stabilized free radical.

This particularly preferred regulator of the general formula (VIb) derives from the regulator of the general formula (VI) in that
n and m are respectively=0,
t is equal to 1,
X is sulphur,
Z has the meanings previously specified for the general formula (VI) and
R has the meanings previously specified for the general formula (VI) for the variant b) where m=0, but with the restriction that, after homolytic cleavage of the S—R bond, R forms either a secondary, tertiary or aromatically stabilized free radical.

These particularly preferred regulators of the general formula (VIb) therefore involve, as a function of whether Z and R within the context of the prescribed meanings are identical or not, symmetrical or asymmetrical trithiocarbonates.

Particular preference is given to using a regulator of the general formula (VIb) in which
Z has the meanings previously specified for the general formula (VI) and
R, with the proviso that, after homolytic cleavage of the S—R bond, R forms either a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or mono- or polyunsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)aralkyl moiety, very particularly preferably benzyl, phenylethyl or 1-methyl-1-phenyleth-2-yl, or
   is thiocarboxy, carbonyl, carboxy, oxo, thioxo, epoxy, or else a salt of the abovementioned compounds.

It is also particularly preferable to use a regulator of the general formula (VIb) in which
Z has the meanings previously specified for the general formula (VI), but likewise with the additional restriction to meanings such that, after homolytic cleavage of the Z—S bond, Z forms either a secondary, tertiary or aromatically stabilized free radical.

A trithiocarbonate regulator is then involved here in which the two moieties R and Z have polymerization-initiating effect.

It is also very particularly preferable to use a regulator of the general formula (VIb) in which
R and Z are identical or different and, with the proviso that, after homolytic cleavage of the R—S and, respectively, Z—S bond, R and Z respectively form a secondary, tertiary or aromatically stabilized free radical,
   are a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   are a saturated or mono- or polyunsaturated, optionally mono- or polysubstituted carbocyclyl or heterocyclyl moiety, in particular cyclohexyl, cumyl or cyclohexane-1-nitrile-1-yl,
   are a (hetero)aryl moiety, very particularly preferably a C₆-C₂₄-(hetero)aryl moiety, in particular phenyl, pyridinyl or anthracenyl,
   are a (hetero)aralkyl moiety, very particularly preferably benzyl, phenylethyl or 1-methyl-1-phenyleth-2-yl, or
   are thiocarboxy, carbonyl, carboxy, oxo, thioxo, epoxy, or else a salt of the abovementioned compounds.

In relation to the wordings used for the general formula (VIb) and hereinafter for the general formulae (VIc), (VId) and (VIe) “that, after homolytic cleavage of the R—S bond, R forms a secondary or tertiary free radical”, the definitions below are applicable. These also apply in analogous form for the corresponding wording “that, after homolytic cleavage of the Z—S bond, Z forms a secondary or tertiary free radical”, to the extent that this is used in connection with Z in the context of the application.

The atom in the moiety R that produces the bond to S in the general formula (VIb) (and, respectively, in the subsequent general formulae (VIc), (VId) and (VIe)) then leads, on homolytic cleavage of the R—S bond, to a free radical which is referred to as “tertiary” when this atom has attached to it (with the exception of the bond to the sulphur) at least

(i) three substituents via single bonds, or
(ii) one substituent via a single bond and a further substituent via a double bond, or
(iii) one substituent via a triple bond,
all of the abovementioned substituents necessarily being other than hydrogen.

The atom in the moiety R that produces the bond to S in the general formulae (VIb), (VIc), (VId) and (VIe) then leads, on homolytic cleavage of the R—S bond, to a free radical identified as being “secondary”, when attached to said atom there

(i) are two substituents via single bonds or
(ii) is one substituent via a double bond,
it being necessary for all of the abovementioned substituents to be other than hydrogen, and all other possible substituents being H.

Examples of moieties R or Z which on homolytic cleavage of the R—S (or Z—S) bond result in a free radical referred to as “tertiary” are tert-butyl, cyclohexane-1-nitrile-1-yl and 2-methylpropanenitrile-2-yl.

Examples of moieties R or Z which on homolytic cleavage of the R—S (or Z—S) bond result in a free radical referred to as “secondary” are sec-butyl, isopropyl and cycloalkyl, preferably cyclohexyl.

In relation to the proviso used hereinafter for the formula (VId) “that, after homolytic cleavage of the Z—S bond, Z forms a primary free radical”, the following definition is applicable: the atom in the moiety Z that produces the bond to S in the general formula (VId) then leads, on homolytic cleavage of the Z—S bond, to a free radical which is referred to as “primary” when this atom has no, or at most one, non-hydrogen substituent attached to it via a single bond. Compliance with the abovementioned proviso is regarded as achieved by definition if Z═H.

Examples of moieties Z which result, on homolytic cleavage of the Z—S bond, in a free radical referred to as “primary” are, therefore, H, linear C₁-C₂₀ alkyl moieties, OH, SH, SR and C₁-C₂₀ alkyl moieties with branches beyond the C atom that produces the bond to S.

Dithioesters:

Another preferred regulator that can be used comprises a regulator of the general formula (VIc),

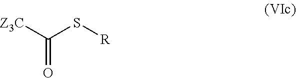

in which
Z has the meanings previously specified for the general formula (VI),
R has the meanings previously specified for the general formula (VI) for the variant b) where m=0 but with the restriction that, after homolytic cleavage of the S—R bond, R forms either a secondary, tertiary or aromatically stabilized free radical.

This particularly preferred regulator of the general formula c) derives from the regulator of the general formula (VI), where
n and m are respectively=0,
t is equal to 1,
X is C(Z)₂,
Z has the meanings previously specified for the general formula (VI) and
R has the meanings previously specified for the general formula (VI) for the variant b) where m=0, but with the restriction that, after homolytic cleavage of the S—R bond, R forms either a secondary, tertiary or aromatically stabilized free radical.

It is particularly preferable to use a regulator of the general formula (VIc) in which

R, with the proviso that, after homolytic cleavage of the S—R bond, R forms either a secondary, tertiary or aromatically stabilized free radical,
is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
is a saturated or unsaturated, optionally mono- or polysubstituted carbocyclyl or heterocyclyl moiety, in particular cyclohexyl, cumyl or cyclohexane-1-nitrile-1-yl,
is a (hetero)aryl moiety, very particularly preferably a C₆-C₂₄-(hetero)aryl moiety, in particular phenyl, pyridinyl or anthracenyl,
is a (hetero)arylalkyl moiety, very particularly preferably a C₇-C₂₅-(hetero)arylalkyl moiety, in particular benzyl, phenylethyl or 1-methyl-1-phenyleth-2-yl, or
is thiocarboxy, carbonyl, carboxy, oxo, thioxo, epoxy, or else a salt of the abovementioned compounds.

Asymmetrical Trithiocarbonates:

Another preferred embodiment uses at least one regulator of the general formula (VId),

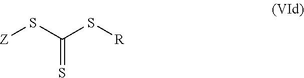

in which
Z has the meanings previously specified for the general formula (VI), but with the restriction that, after homolytic cleavage of the S—Z bond, Z forms a primary free radical, and
R can have the same meanings as Z in the general formula (VI), but with the restriction that, after homolytic cleavage of the S—R bond, R forms either a secondary, tertiary or aromatically stabilized free radical, and
   with the additional proviso that Z and R assume different meanings.

This preferred regulator of the general formula (VId) derives from the regulator of the general formula (VI) where
n and in are respectively=0,
t is equal to 1,
X is sulphur,
Z has the meanings previously specified for the general formula (VI), but with the restriction that, after homolytic cleavage of the S—Z bond, Z forms a primary free radical, and
R can have the same meanings as Z in the general formula (VI), but with the restriction that, after homolytic cleavage of the S—R bond, R forms either a secondary, tertiary or aromatically stabilized free radical.

These particularly preferred regulators of the general formula (VId) therefore involve asymmetrical trithiocarbonates.

Particular preference is given to a regulator of the abovementioned general formula (VId) in which
Z, with the proviso that, after homolytic cleavage of the S—Z bond, Z forms a primary free radical, is H, a linear or branched, saturated or mono- or polyunsaturated, optionally mono- or polysubstituted alkyl moiety, very particularly preferably a corresponding C₁-C₁₆ alkyl moiety, in particular methyl, ethyl, n-prop-1-yl, but-2-en-1-yl, n-pent-1-yl, n-hex-1-yl or n-dodecan-1-yl, or aralkyl, very particularly preferably C₇-C₂₅-aralkyl, in particular benzyl, amino, amido, carbamoyl, hydroxyimino, alkoxy, aryloxy, F, Cl, Br, I, hydroxy, alkylthio, arylthio, carbonyl, carboxy, oxo, thioxo, cyanates, thiocyanates, isocyanates, thioisocyanates, isocyanides or a salt of the compounds specified and
R, with the proviso that, after homolytic cleavage of the S—R bond, R forms either a secondary, tertiary or aromatically stabilized free radical,
   is a linear, branched or cyclic, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or unsaturated, optionally mono- or polysubstituted carbocyclyl or heterocyclyl moiety, in particular cyclohexyl, cumyl or cyclohexane-1-nitrile-1-yl,
   is an aryl moiety or heteroaryl moiety, very particularly preferably a C₆-C₂₄-aryl moiety, in particular phenyl, pyridinyl or anthracenyl,
   is an aralkyl moiety, very particularly preferably benzyl, phenylethyl or 1-methyl-1-phenyleth-2-yl, or
   is thiocarboxy, carbonyl, carboxy, oxo, thioxo, epoxy, or else a salt of the abovementioned compounds.

Dithioesters:

Another preferred embodiment uses at least one regulator of the general formula (VIe),

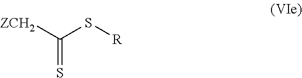

in which
Z can have any of the meanings specified for the general formula (VI) and
R can have the same meanings as Z in the general formula (VI), but with the restriction that, after homolytic cleavage of the S—R bond, R forms either a secondary, tertiary or aromatically stabilized free radical.

This preferred regulator of the general formula (VIe) derives from the regulator of the general formula (VI), where
n and m are respectively=0,
t is equal to 1,
X is CH₂,
Z has the meanings previously specified for the general formula (VI) and
R can have the same meanings as Z in the general formula (VI), but with the restriction that, after homolytic cleavage of the S—R bond, R forms either a secondary, tertiary or aromatically stabilized free radical.

Particular preference is given to a regulator of the abovementioned general formula (VIe), in which
R, with the proviso that, after homolytic cleavage of the S—R bond, R forms either a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, prop ionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or unsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)arylalkyl moiety, very particularly preferably a C₇-C₂₅-(hetero)arylalkyl moiety, in particular benzyl, phenylethyl or 1-methyl-1-phenyleth-2-yl, or
   is thiocarboxy, carbonyl, carboxy, oxo, thioxo, epoxy, or else a salt of the abovementioned compounds.

All of the abovementioned regulators can be synthesized by methods familiar from the prior art to the person skilled in the art. Synthesis instructions and other references for production instructions can be found by way of example in Polymer 49 (2008) 1079-1131 and in any of the patents and literature references mentioned previously as prior art in this application. Many of the regulators are also already obtainable commercially.

The following are particularly suitable as regulators in embodiment (1) of the free-radical polymerization to give the nitrite rubber: dodecylpropanoic acid trithiocarbonate (DoPAT), dibenzoyl trithiocarbonate (DiBenT), cumyl phenyl dithioacetate (CPDA), cumyl dithiobenzoate, phenyl ethyl dithiobenzoate, cyanoisopropyl dithiobenzoate (CPDB), 2-cyanopropyl dodecyl trithiocarbonate, 2-cyanoethyl-dithiobenzoate, 2-cyanoprop-2-yl dithiophenylacetate, 2-cyanoprop-2-yl dithiobenzoate, S-thiobenzoyl-1H,1H,2-keto-3-oxa-4H,4H,5H,5H-perfluoroundecanethiol and S-thiobenzoyl-1-phenyl-2-keto-3-oxa-4H,4H,5H,5H-perfluoroundecanethiol.

It is usual in embodiment (1) of the free-radical polymerization to give the nitrile rubber to use from 5 to 2000 mol % of the regulator, based on 1 mol of the initiator. It is preferable to use from 20 to 1000 mol % of the regulator, based on 1 mol of the initiator.

The compounds that can be used in embodiment (1) of the free-radical polymerization to give the nitrile rubber and that have the general formula (VIb) are known from the so-called RAFT technology.

Embodiment (2) of the Free-Radical Polymerization to Give the Nitrile Rubber:

Embodiment (2), which is subject matter of an as yet unpublished European patent application with the application number 10174654.3, uses at least one compound selected from the group consisting of the abovementioned compounds (i) to (xii).

Preferred mercaptans (i) are alkyl mercaptans, particular preference being given to C₁-C₁₆ alkyl mercaptans, which may be branched or unbranched. Especially preferred are methyl mercaptan, ethyl mercaptan, n-butyl mercaptan, n-hexyl mercaptan, n-octyl mercaptan, n-dodecyl mercaptan and tert-dodecyl mercaptans. Tertiary dodecyl mercaptans can be used in the form of individual isomers and in the form of mixtures of two or more isomers.

Preferred mercapto alcohols (ii) are aliphatic or cycloaliphatic mercapto alcohols, more particularly 2-mercapto-1-ethanol, 3-mercapto-1-propanol, 3-mercaptopropane-1,2-diol (also known as thioglycerol), 4-mercapto-1-butanol and 2-mercaptocyclohexanol.

Preferred mercaptocarboxylic acids (iii) are mercaptoacetic acid (also designated sulphanylacetic acid), 3-mercaptopropionic acid, mercaptobutanedioic acid (also known as mercaptosuccinic acid), cysteine and N-acetylcysteine. Preferred mercaptocarboxylic esters (iii) are alkyl thioglycolates, more particularly ethylhexyl thioglycolate.

A preferred thiocarboxylic acid (iv) is thioacetic acid.

Preferred disulphides (v) are xanthogen disulphides, particular preference being given to diisopropylxanthogen disulphide.

Preferred allyl compounds (vii) are allyl alcohol or allyl chloride.

A preferred aldehyde (crotonaldehyde.

Preferred aliphatic or araliphatic halohydrocarbons (ix) are chloroform, carbon tetrachloride, iodoform or benzyl bromide.

The abovementioned molar-mass regulators are known in principle from the literature (see K. C. Berger and G. Brandrup in J. Brandrup, E. H. Immergut, Polymer Handbook, 3rd edn., John Wiley & Sons, New York, 1989, p. II/81-II/141) and are available commercially or alternatively may be prepared by methods from the is literature which are known to the skilled person (see, for example, Chimie & Industrie, Vol. 90 (1963), No. 4, 358-368, U.S. Pat. No. 2,531,602, DD 137 307, DD 160 222, U.S. Pat. No. 3,137,735, WO-A-2005/082846, GB 823,824, GB 823,823, JP 07-316126, JP 07-316127, JP 07-316128).

A feature of molar-mass regulators is that in the context of the polymerization reaction they accelerate chain-transfer reactions and hence bring about a lowering of the degree of polymerization of the resultant polymers. The abovementioned regulators include mono-, di- and polyfunctional regulators, depending on the number of functional groups in the molecule that are able to lead to one or more chain-transfer reactions.

The molar mass regulators for use in the process of the invention are more preferably tert-dodecyl mercaptans, in the form of individual isomers and in the form of mixtures of two or more isomers.

tert-Dodecyl mercaptans are often prepared by accidently catalysed addition reaction of hydrogen sulphide with olefins having 12 carbons. As C₁₂ olefin starting material (also referred to as “C₁₂ feedstock”), use is made predominantly of oligomer mixtures based on tetramerized propene (also called “tetrapropene” or “tetrapropylene”), trimerized isobutene (also called “triisobutene” or “triisobutylene”), trimerized n-butene and dimerized hexene.

As molar-mass regulators in the process of the invention it is especially preferred to use one or more tert-dodecyl mercaptans selected from the group consisting of 2,2,4,6,6-pentamethylheptane-4-thiol, 2,4,4,6,6-pentamethylheptane-2-thiol, 2,3,4,6,6-pentamethylheptane-2-thiol, 2,3,4,6,6-pentamethylheptane-3-thiol and any desired mixtures of two or more of the abovementioned isomers.

Use is made more particularly in variant (2) of the free-radical polymerization to give the nitrile rubber of a mixture comprising 2,2,4,6,6-pentamethylheptane-4-thiol, 2,4,4,6,6-pentamethylheptane-2-thiol, 2,3,4,6,6-pentamethylheptane-2-thiol and 2,3,4,6,6-pentamethylheptane-3-thiol. The preparation of this mixture is described in EP-A-2 162 430.

It is usual in variant (2) of the process according to the invention to use from 1 to 5000 mol % of the molar-mass regulator (i) to (ix), based on 1 mol of initiator. It is preferable to use from 5 to 2000 mol % of the molar-mass regulator, based on 1 mol of the initiator.

Embodiment (3) of the Free-Radical Polymerization to Give the Nitrile Rubber:

In embodiment (3), which is subject matter of an as yet unpublished European patent application with the application number 10174665.9, the polymerization to give the nitrile rubber can be carried out in at least one solvent even in the absence of any compounds which are used for embodiments (1) and also (2), defined as compounds (i) to (xi).

Initiators of the Free-Radical Polymerization to Give the Nitrile Rubber:

The manner in which the free-radical polymerization to give the nitrile rubber is initiated is not critical. It is possible to use initiation by peroxidic initiators, azo initiators and redox systems, or photochemical initiation. Preference is given to azo initiators.

The following compounds can be used by way of example as azo initiators: 2,2′-azobis(isobutyronitrile), 2,2′-azobis(2-cyano-2-butane), dimethyl 2,2′-azobisdimethylisobutyrate, 4,4′-azobis(4-cyanopentanoic acid), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl]propionamide, 2,2′-azobis(N,N-dimethyleneisobutyramidine)dihydrochloride, 2,2′-azobis(2-amidinopropane)dihydrochloride, 2,2′-azobis(N,N′-dimethyleneisobutyramine), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), 1,1′-azobis(cyclohexane-1-carbonitrile), 2,2′-azobis[N-(2-propenyl)-2-methylpropionamide], 1-[(1-cyano-1-methylethyl)azo]formamide, 2,2′-azobis(N-butyl-2-methylpropionamide), 2,2′-azobis(N-cyclohexyl-2-methylpropionamide) and 2,2′-azobis(2,4,4-trimethylpentane).

The azo initiators are used typically in an amount of 10⁻⁴ to 10⁻¹ mol/l, preferably in an amount of 10⁻³ to 10⁻² mol/l. By harmonizing the proportion of the amount of initiator used to the amount of the regulator used, success is achieved in specifically influencing not only the reaction kinetics but also the molecular structure (molar mass, polydispersity).

Peroxidic initiators that can be used include, for example, the following peroxo compounds, containing an —O—O unit: hydrogen peroxide, peroxodisulphates, peroxodiphosphates, hydroperoxides, peracids, peracid esters, peracid anhydrides and peroxides having two organic moieties. As salts of peroxodisulphuric acid and of peroxodiphosphoric acid it is possible to use sodium, potassium and ammonium salts. Examples of suitable hydroperoxides include t-butyl hydroperoxide, cumene hydroperoxide, pinane hydroperoxide and p-menthane hydroperoxide. Suitable peroxides having two organic moieties are dibenzoyl peroxide, 2,4-dichlorobenzoyl peroxide, 2,5-dimethylhexane-2,5-di-t-butyl peroxide, bis(t-butylperoxyisopropyl)benzene, t-butyl cumyl peroxide, di-t-butyl peroxide, dicumyl peroxide, t-butyl perbenzoate, t-butyl peracetate, 2,5-dimethylhexane 2,5-diperbenzoate, t-butyl per-3,5,5-trimethylhexanoate or 1,1-bis(tert-butylperoxy)-3,5,5-trimethylcyclohexane. Preference is given to using p-menthane hydroperoxide, cumene hydroperoxide, pinane hydroperoxide or 1,1-bis(tert-butylperoxy)-3,5,5-trimethylcyclohexane.

In this case it has been found appropriate to select the azo initiator or peroxidic initiator such that the half-life of the respective initiator in the selected solvent is 10 hours or more than 10 hours at a temperature of 20° C. to 200° C., preferably 45° C. to 175° C., more preferably 50° C. to 160° C. and more particularly 85° C. to 150° C. Preference is given here to azo initiators which possess a half-life of 10 hours or more than 10 hours in the selected solvent at a temperature of 20° C. to 200° C., preferably 80° C. to 175° C., more preferably 45° C. to 160° C. and very particularly preferably 50° C. to 150° C.

One embodiment uses azo initiators of the following structural formulae (Ini-1)-(Ini-6):

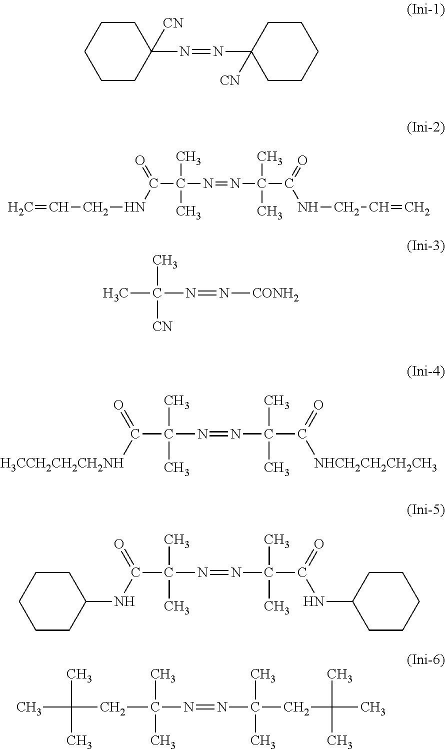

Especially preferred is the use of the initiators of the formulae (Ini-2) and (Ini-3).

The above azo initiators of the structural formulae (Ini-1)-(Ini-6) are available commercially, for example from Wako Pure Chemical Industries, Ltd.

The concept of the half-life is familiar to the skilled person in connection with initiators. Merely as an example: a half-life of 10 hours in a solvent at a particular temperature means specifically that, under these conditions, half of the initiator has undergone decomposition after 10 hours.

When the above preferred initiators with a relatively high decomposition temperature are used, especially the stated azo initiators, it is possible to synthesize nitrile rubbers having comparatively higher average molar mass Mw (weight average of the molar mass) and Mn (number average of the molar mass) which are also notable at the same time for a high linearity. This is manifested by correspondingly low values for the Mooney relaxation, measured by ISO 289 parts 1 & 2 or alternatively in accordance with ASTM D1646.

Redox systems which can be used are the following systems composed of an oxidizing agent and a reducing agent. The choice of suitable amounts of oxidizing agent and reducing agent is sufficiently familiar to the skilled person.

In the case where redox systems are used, it is common to make additional use of salts of transition metal compounds such as iron, cobalt or nickel in combination with suitable complexing agents such as sodium ethylenediaminetetraacetate, sodium nitrilotriacetate and also trisodium phosphate or tetrapotassium diphosphate.

Oxidizing agents which can be used in this context include, for example, all peroxo compounds identified above for the peroxidic initiators.

Reducing agents which can be used in the process of the invention include, for example, the following: sodium formaldehydesulphoxylate, sodium benzaldehydesulphoxylate, reducing sugars, ascorbic acid, sulphenates, sulphinates, sulphoxylates, dithionite, sulphite, metabisulphite, disulphite, sugars, urea, thiourea, xanthogenates, thioxanthogenates, hydrazinium salts, amines and amine derivatives such as aniline, dimethylaniline, monoethanolamine, diethanolamine or triethanolamine. Preference is given to using sodium formaldehydesulphoxylate.

The free-radical polymerization may also be initiated photochemically as described below: for this purpose a photoinitiator is added to the reaction mixture, the photoinitiator being excited by exposure to light of appropriate wavelength, and initiating a free-radical polymerization. Here it should be noted that for the optimum initiation of the free-radical polymerization, the irradiation time is dependent on the power of the radiation source, on the distance, the radiation source and the reaction vessel, and on the area of irradiation. To the skilled person, however, it is readily possible, by means of various test series, to determine the optimum irradiation time. The choice of the suitable amount of initiator is also possible without problems to a skilled person, and is used to influence the time/conversion behaviour of the polymerization.

Examples of photochemical initiators which can be used include the following: benzophenone, 2-methylbenzophenone, 3,4-dimethylbenzophenone, 3-methylbenzophenone, 4,4′-bis(diethyl-amino)benzophenone, 4,4′-dihydroxybenzophenone, 4,4′-bis[2-O-propenyl)phenoxyl]benzophenone, 4-(diethylamino)benzophenone, 4-(dimethylamino)benzophenone, 4-benzoylbiphenyl, 4-hydroxybenzophenone, 4-methylbenzophenone, benzophenone-3,3′,4,4′-tetracarboxylic dianhydride, 4,4′-bis(dimethylamino)benzophenone, acetophenone, 1-hydroxycyclohexyl phenyl ketone, 2,2-diethoxyacetophenone, 2,2-dimethoxy-2-phenylacetophenone, 2-benzyl-2-(dimethylamino)-4′-morpholinobutyrophenone, 2-hydroxy-2-methylpropiophenone, 2-hydroxy-4′-(2-hydroxyethoxy)-2-methylpropiophenone, 3′-hydroxyacetophenone, 4′-ethoxyacetophenone, 4′-hydroxyacetophenone, 4′-phenoxyacetophenone, 4′-ten-butyl-2°,6′-dimethylacetophenone, 2-methyl-4′-(methylthio)-2-morpholinopropiophenone, diphenyl(2,4,6-trimethylbenzoyl)phosphine oxide, phenylbis(2,4,6-trimethylbenzoyl)phosphine oxide, methyl benzoylformate, benzoin, 4,4′-dimethoxybenzoin, benzoin methyl ether, benzoin ethyl ether, benzoin isopropyl ether, benzoin isobutyl ether, 4,4′-dimethylbenzil, hexachlorocyclopentadienes or a combination thereof.

Temperature of the Free-Radical Polymerization:

The free-radical polymerization is typically conducted at a temperature in the range from 5° C. to 150° C., preferably in a range from 8° C. to 130° C., more preferably in a range from 9′C to 120° C. and very preferably in a range from 10° C. to 110*C. Particularly when employing a temperature in the range from 40° C. to 110° C., and in even more pronounced form in the range from 60 to 110° C., distinct formation is observed of Diels-Alder by-products of the monomers. If the temperature selected is even lower, the polymerization is slowed accordingly. At significantly higher temperatures, above 150° C., it is not impossible for the initiator used to decompose too quickly or for the RAET agent to be decomposed in the case of embodiment (1). Especially when using peroxidic initiators, moreover, it is not impossible for oxidation of the regulator to occur in certain circumstances.

Polymerization:

In the case of initiation by peroxo compounds or azo initiators, the conduct of the free-radical polymerization to give the nitrite rubber is usually such that the α,β-unsaturated nitrile and the optionally used other copolymerizable monomers, the solvent, the initiator and the regulator(s) form an initial charge in a reaction vessel, and then the conjugated diene(s) is/are metered into the mixture. The polymerization process is then initiated through temperature increase.

In the case of initiation by means of a redox system, the oxidizing agent is typically metered into the reaction vessel together with one of the monomers. The polymerization process is then initiated through addition of the reducing agent.

A useful method which is certainly familiar to the person skilled in the art for obtaining specific ratios of the respective monomers in the co/terpolymer is to undertake appropriate metering modifications (e.g. by metering further amounts of monomer, of initiator, of regulator or of solvent into the mixture). These further amounts can be metered into the mixture either continuously or else batchwise in individual portions.

A method which has proved successful for adjusting to a suitable molar mass, and also for purposes of achieving the desired conversion, in one embodiment of the process according to the invention, meters further amounts not only of the initiator but also of solvent on one or more occasions during the course of the polymerization reaction.

Nitrile Rubbers:

In embodiment (1) the resultant nitrile rubbers feature the presence of one or more structural elements of the general formulae (I), (II), (III), (IV) or (V) either in the main polymer chain or as terminal groups. Nitrile rubbers of this type can, by virtue of the said structural elements/terminal groups, be subjected to downstream reactions with other polymerizable monomers, since the structural elements/terminal groups can function as RAFT agents by way of further fragmentation. This method permits the targeted construction of a very wide variety of polymer architectures. Furthermore, these nitrile rubbers can, later, also be crosslinked more easily than conventional nitrile rubbers, since the structural elements/terminal groups are structurally similar to the conventional crosslinking agents, in particular to those based on sulphur. To this extent, it is possible to achieve an adequate crosslinking density with the nitrile rubbers even with a relatively small amount of crosslinking agent. Furthermore, crosslinking by way of the terminal groups reduces the number of loose polymer-chain ends in the vulcanizate, thus giving improved properties, e.g. dynamic properties.

These nitrile rubbers comprise
(i) repeat units derived from at least one conjugated diene, from at least one α,β-unsaturated nitrile and optionally from one or more other copolymerizable monomers and
(ii) one or more structural elements of the general formulae (I), (II), (III), (IV) or (V)

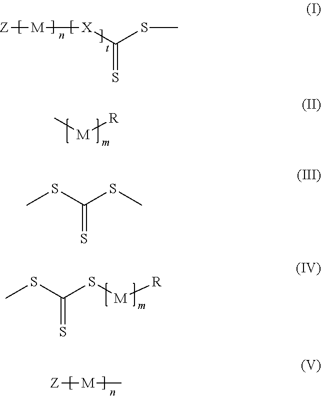

where
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, nitrile, carbonyl, carboxy, oxycarbonyl, oxysulphonyl, oxo, thioxo, borates, selenates, epoxy, cyanates, thiocyanates, isocyanates, thioisocyanates and isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, polycarbonates, polyurethanes, polyisocyanates, polysaccharides, polyesters and polyamides,
n and m are identical or different and are respectively in the range from 0 to 10 000,
t is 0 or 1, insofar as n=0, and is 1 insofar as n≠0,
X is C(Z₂), N(Z), P(Z), P(═O)(Z), O, D. S(═O) or S(═O)₂, where Z in these moieties can have the same meanings as stated previously and
R (a) if m≠0, can have the same meanings as the moiety Z and
   (b) if m=0, is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides.

The meanings specified for the abovementioned moieties Z and R can respectively have mono- or polysubstitution. The information already provided in relation to Z and R for the general formula (VI) applies identically here. The information provided for the general formula (VI) in relation to the inclusion of certain meanings for Z and R (in the form of salts of the specified moieties, of organometallic salts, in the form of ligands for organometallic complex compounds, and the coupling by way of linkers to solid phases or to support substances) also applies in identical fashion to Z and R in the general structural elements (I)-(V). The information provided in relation to the optional substitution of the meanings behind M relating to the general formula (VI) also applies in identical fashion to the general structural element (I), (II), (IV) and (V).

By way of embodiment (2) it is preferably possible to obtain optionally hydrogenated nitrile rubbers which comprise structural elements (ii) of the general formulae (VIb-1) and (VIb-2)

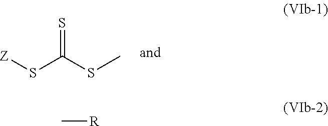

in which
Z has the meanings previously specified for the general formula (I) and
R has the meanings previously specified for the general formula (I), but with the restriction that, after homolytic cleavage of the bond to the next-bonded atom in the nitrile rubber, R forms either a secondary, tertiary or aromatically stabilized free radical.

It has proved particularly successful for Z and R here to be different.

The said structural elements are present as terminal groups in the nitrile rubbers and are obtained on use of the preferred regulators of the general formula (VIb).

One preferred embodiment according to variant (1) gives nitrile rubbers which comprise, as general structural elements (ii), the terminal group n(VIb-1) and (VIb-2), in which R, with the proviso that, after homolytic cleavage of the bond to the next bonded atom, R forms either a secondary, tertiary or aromatically stabilized free radical,
is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H, 1H,2-keto-3-oxo-4H,4H,5H,5H-perfluoroundecanyl, or
is a saturated or mono- or polyunsaturated, optionally mono- or polysubstituted carbocyclyl or heterocyclyl moiety, in particular cyclohexyl, cumyl or cyclohexane-1-nitrile-1-yl,
is a (hetero)aryl moiety, very particularly preferably a C₆-C₂₄-(hetero)aryl moiety, in particular phenyl, pyridinyl or anthracenyl,
is a (hetero)aralkyl moiety, very particularly preferably benzyl, phenylethyl or 1-methyl-1-phenyleth-2-yl, or
is thiocarboxy, carbonyl, carboxy, oxo, thioxo, epoxy, or else a salt of the abovementioned compounds.

One particularly preferred embodiment according to variant (I), gives optionally hydrogenated nitrile rubbers which comprise, as general structural elements (ii),

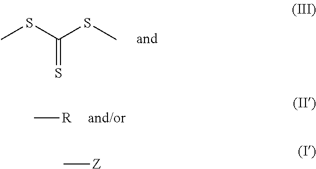

where
Z can have the same meanings as in the general formula (I) and
R can have the same meanings as in the general formula (II) for m=0, and
R and Z are identical or different, but always with the proviso that, after homolytic cleavage of their bond to the respective next atom in the optionally hydrogenated nitrile rubber, R and Z respectively form a secondary, tertiary or aromatically stabilized free radical.

Optionally hydrogenated nitrile rubbers having the abovementioned general structural elements (ii) are obtained when a compound of the general structural formula (VIb) is used as regulator, in which Z has the same meanings as in the general formula (VI) and R has the same meanings as in the general formula (VI) for the variant b) where m=0, and R and Z are identical or different, but always with the proviso that, after homolytic cleavage of their bond to the closest sulphur in the regulator, R and Z respectively form a secondary, tertiary or aromatically stabilized free radical.

Another particularly preferred embodiment according to variant (I), gives nitrile rubbers which comprise, as general structural elements (ii), the elements (III) and (II′) and/or (I′), in which
R and Z are identical or different, and with the proviso that, after homolytic cleavage of the bond to the respective next bonded atom, R and Z respectively form a secondary, tertiary or aromatically stabilized free radical,
   are a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   are a saturated or mono- or polyunsaturated, optionally mono- or polysubstituted carbocyclyl or heterocyclyl moiety, in particular cyclohexyl, cumyl or cyclohexane-1-nitrile-1-yl,
   are a (hetero)aryl moiety, very particularly preferably a C₆-C₂₄-(hetero)aryl moiety, in particular phenyl, pyridinyl or anthracenyl,
   are a (hetero)aralkyl moiety, very particularly preferably benzyl, phenylethyl or 1-methyl-1-phenyleth-2-yl, or
   are thiocarboxy, carbonyl, carboxy, oxo, thioxo, epoxy, or else a salt of the abovementioned compounds.

Another particularly preferred embodiment according to variant (1), gives nitrile rubbers which comprise, as general structural elements (ii),

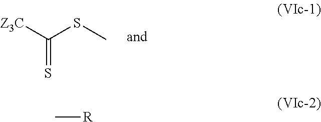

in which
Z has the meanings previously specified for the general formula (I),
R has the meanings previously specified for the general formula (II), but with the restriction that, after homolytic cleavage of the bond to the next atom in the optionally hydrogenated nitrile rubber, R forms a secondary, tertiary or aromatically stabilized free radical.

The said structural elements are present as terminal groups in the nitrile rubbers and are obtained on use of the preferred regulators of the general formula (VIc).

Another particularly preferred embodiment according to variant (1), gives optionally hydrogenated nitrile rubbers which comprise, as general structural elements (ii), the structural elements (VIc-1) and (VIc-2), in which
R, with the proviso that, after homolytic cleavage of the bond to the next atom in the optionally hydrogenated nitrile rubber, R forms a secondary, tertiary or aromatically stabilized free radical,
   is a linear or branched, saturated or mono- or polyunsaturated, optionally mono- or polysubstituted alkyl moiety, preferably a corresponding C₃-C₂₀-alkyl moiety, in particular sec-butyl, tert-butyl, isopropyl, 1-buten-3-yl, 2-chloro-1-buten-2-yl, propionic acid-2-yl, propionitrile-2-yl, 2-methylpropanenitrile-2-yl, 2-methylpropionic acid-2-yl or 1H,1H,2-keto-3-oxo-4H,4H,5H,5H-perfluoroundecanyl, or
   is a saturated or mono- or polyunsaturated, optionally mono- or polysubstituted carbocyclyl or heterocyclyl moiety, in particular cyclohexyl, cumyl or cyclohexane-1-nitrile-1-yl,
   is a (hetero)aryl moiety, very particularly preferably a C₆-C₂₄-(hetero)aryl moiety, in particular phenyl, pyridinyl or anthracenyl,
   is a (hetero)aralkyl moiety, very particularly preferably benzyl, phenylethyl or 1-methyl-1-phenyleth-2-yl, or
   is thiocarboxy, carbonyl, carboxy, oxo, thioxo, epoxy, or else a salt of the abovementioned compounds.

In the ease of embodiment (2), the nitrile rubbers obtained feature one or more structural elements either in the main polymer chain or as terminal groups, these elements being produced by incorporation and/or reaction of one of the molar-mass regulators (i) to (x), defined for variant (2), with the polymer chains formed.

In all three embodiments (1)-(3), a feature of the resultant nitrile rubbers is that, unlike corresponding rubbers which are obtained by way of emulsion polymerization according to the prior art, they are completely emulsifier-free and also contain none of the salts that are usually used for coagulation of the latices after emulsion polymerization, for purposes of precipitation of the nitrile rubber. They do, however, contain the Diels-Alder by-products already described earlier on above in this specification.

Ultrafiltration:

The process of the invention uses a solution of the unpurified nitrile rubber in an organic solvent. Organic solvents used may be a wide variety of organic solvents, or mixtures of two or more solvents. The nitrile rubber to be purified ought advantageously to dissolve at >90% by weight under the particular process conditions selected. Preferred solvents are aromatic, aliphatic and/or chlorinated solvents, and also ketones and cyclic ethers. Particularly preferred are dimethylacetamide, ethyl acetate, 1,4-dioxane, acetonitrile, tert-butanol, tert-butylnitrile, dimethyl carbonate, methyl acetate, isobutyronitrile, acetone, toluene, benzene, chlorobenzene, chloroform, methylene chloride, methyl ethyl ketone, tetrahydrofuran, or mixtures of two or more of these solvents.

The process of the invention allows the nitrile rubber with Diels-Alder by-product impurities, obtained by free-radical polymerization in at least one organic solvent, to be subjected to ultrafiltration directly, without further isolation. In one particular embodiment here it is possible, before the process of the invention is implemented, for the unreacted monomers to be removed from the solution of the impure nitrile rubber. This is preferably done by stripping. It is also possible first to isolate the impure nitrile rubber obtained by polymerization in organic solution, and then to dissolve it again in at least one organic solvent and subject it to the ultrafiltration of the invention. This alternative is judicious if the ultrafiltration is to be carried out in a different organic solvent from the preceding solution polymerization. It may also be useful to subject the nitrile rubber that is to be used to a filtration prior to the ultrafiltration.

For ultrafiltration, the solution of the unpurified nitrile rubber is passed at a temperature in the range from 10 to 150° C., using a pressure in the range from 1 to 80 bar, over an ultrafiltration membrane one or more times. This produces a retentate stream, which contains the purified nitrile rubber and does not flow through the ultrafiltration membrane, and a permeate stream, which contains Diels-Alder by-products and which passes through the ultrafiltration membrane, the flow rate of the retentate stream during the ultrafiltration being set to a level greater than 0.2 m/sec. The passing of the solution over an ultrafiltration membrane one or more times is also referred to as single or multiple “overpassage” of the membrane.

The ultrafiltration membrane must have at least one semi-permeable membrane which is pervious for the solvent/solvents and the Diels-Alder by-products contained therein, but impervious for the nitrile rubber. Accordingly, a permeate stream containing Diels-Alder by-products is obtained, and also a retentate stream, which contains the purified nitrile rubber with a Diels-Alder by-products content reduced by at least 50% by weight. With each overpassage, the amount of Diels-Alder by-products in the retentate stream is reduced. The volume of solvent separated off with the permeate stream is typically replenished by addition of fresh solvent to the retentate stream, if concentration of the retentate steram is to be avoided. Through the choice of the number of overpassages and of the amount of solvent replaced, it is possible to adjust the residual concentration of the Diels-Alder by-products in the purified nitrile rubber. Under these conditions, the depletion of the Diels-Alder by-products is determined by their retention and by the diafiltration coefficient (quantitative ratio of permeate to retentate).

The process of the invention can be carried out either discontinuously or continuously. In one preferred embodiment, the process of the invention is carried out discontinuously. Discontinuously here means that the originally employed solution of the unpurified nitrile rubber is subjected to the ultrafiltration, by means of the desired number of overpassages, without a further quantity of unpurified nitrile rubber solution being added to the retentate stream in the course of the passages.

The ultrafiltration is typically carried out in the process of the invention at a temperature in the range from 10° C. to 150° C., preferably in the range from 20° C. to 130° C., and at a pressure in the 1 to 80 bar range, preferably in the range from 2 bar to 50 bar.

In the process of the invention, the flow rate of the retentate stream past the membrane is not to fall below 0.2 m/sec, since otherwise, at higher concentrations of the nitrile rubber in the solvent, more particularly a concentration of greater than 3% by weight, it is possible for what is called concentration polarization to occur, thereby lowering the permeate flow rate. Preferred flow rates are in the range from 1 to 10 m/sec, more preferably 2 to 10 m/sec.

The concentration of the nitrile rubber in the solution of nitrile rubber, Diels-Alder by-products and, optionally, further interfering substances, that is to be treated by ultrafiltration, is typically up to 40% by weight, based on the sum of solvent(s), nitrile rubber, Diels-Alder by-products and, optionally, further interfering substances. If a higher concentration is selected, the viscosity rises too sharply. This in turn is dependent on the molar mass and on the monomer composition of the nitrile rubber. A certain reduction in the viscosity of the nitrile rubber solution is possible through heating of the polymer solution. The concentration of the nitrite rubber in the solution that is to be treated by ultrafiltration is preferably in the range from 5 to 20% by weight.

Definition of the Ultrafiltration Membrane:

The ultrafiltration membrane for use in the process of the invention has one or more layers, and the layer having the smallest pores must possess a pore diameter in the 1-200 nm range. A preferred ultrafiltration membrane is one which has at least one high-porosity, permeable outer layer and one or more fine, porous inner layers, of which that having the smallest pores has a pore diameter in the range from 1 to 200 nm. The high-porosity outer layer or layers function(s) in particular as support layer(s) and may constitute a woven or nonwoven fabric or a ceramic body. By high-porosity is meant a pore diameter of the outer layer(s) in the region of typically greater than 500 nm. The inner layer or layers is/are typically of finer porosity than the respective outer layer(s). The inner layers are symmetrical or asymmetrical membranes, applied to the outer layers, and may be constructed, for example, from suitable polymers or from another fine porous ceramic layer. The pore diameters of the inner layers may also become continuously smaller from outside to inside. The pore size of the most finely porous layer is in the range from 1 nm to 200 nm, preferably in the range from 1 to 100 nm and more preferably in the range from 1 to 50 nm. The pore sizes may be determined by methods known to the skilled person. The cut-off of an ultrafiltration membrane of this kind that is used is therefore in the range from 1 to 200 nm, preferably in the range from 1 to 100 nm and more preferably in the range from 1 to 50 nm. Additionally, the ultrafiltration membrane may have a thin layer on the surface, optionally containing ionic groups,

Suitable membrane polymers for both the outer and inner layer(s) are polysulphones, polyethersulphones, polyamides, polyetherketones, polyureas, polyurethanes, poiyvinylidene difluoride, cellulose acetates, cellulose nitrates, polycarbonates, polyacrylonitrile and polyepoxides. Ceramic building materials as well may be used as membranes, based for example on in some cases mixed oxides, carbonates, carbides and nitrides of the elements aluminium, antimony, barium, beryllium, bismuth, boron, hafnium, cobalt, manganese, magnesium, nickel, silicon, thorium, titanium, tungsten and zirconium.

The ultrafiltration membrane is typically part of a membrane module. Module types contemplated here include all commercial types known to the skilled person, Preference is given to plate modules, wound modules, tube modules, capillary modules and multi-channel modules, which may optionally be assisted by integrated flow disruptors.

By means of the process of the invention it is possible for the Diels-Alder by-products to be removed in stages, but also for different concentrations of these Diels-Alder by-products to be set in the nitrile rubber solution.

The solution of the nitrile rubber treated by the process of the invention (retentate) can be marketed directly as such or isolated by work-up techniques known to the skilled person, such as degassing and spray-drying or coagulation in water, optionally with addition of salt, or using other suitable polar solvents, with subsequent drying, in the form of powder, crumb or bale. Other drying techniques, such as evaporation, thin-film evaporation or freeze-drying, are likewise possible. Dry finishing as well can be employed, as described for nitrile rubbers in EP-A-2 368 916.

In another particular version of the process of the invention, a purified nitrite rubber whose Diels-Alder by-products content has been reduced by the ultrafiltration can be hydrogenated in a further step, using a transition metal catalyst. This solution of the hydrogenated nitrile rubber, carrying transition metal catalyst and/or constituents thereof, may in turn also be subjected to an ultrafiltration process. In that case it is possible not only to produce purified, hydrogenated nitrile rubber, but also to recover the expensive transition metal catalyst.

By means of the process of the invention it is possible to produce purified nitrile rubbers and/or hydrogenated downstream products thereof, in which the amount of Diels-Alder by-products is reduced by at least 50% by weight relative to the amount in the unpurified nitrile rubber originally employed. The purified nitrile rubbers and/or hydrogenated downstream products thereof that are obtained by the process of the invention are notable for a number of advantages. They exhibit lower mould fouling in injection-moulding applications, and can be used in food contact, in the cosmetic and medical segments, and also in the electronics sector. One decisive advantage of the purified nitrile rubbers obtained is that in subsequent value-adding operations, such as a hydrogenation or metathesis, for example, disadvantages that are anticipated as a result of side-reactions, corrosion effects or catalyst deactivation are minimized. In these hydrogenation and/or metathesis reactions it is possible, advantageously, to operate with reduced amounts of catalyst, and the maintenance costs are lower, owing to lower corrosion potentials. Furthermore, the ultrafiltration can easily be implemented on an industrial scale as well.

### EXAMPLES

In the examples, the following nitrile rubbers were used, in the form of copolymers of acrylonitrile and butadiene:

TABLE 1

| | | | Amount of Diels-Alder |
|---|---|---|---|
| NBR | | | by-products, based on 100% |
| Type | ACN content | Mw | by weight nitrile rubber |
| A | 32.7% | 427 000 g/mol | 113.6% by weight |
| B | 33.3% | 202 000 g/mol | 39.6% by weight |
| C | 33% | 221 000 g/mol | 46.8% by weight |

The Diels-Alder by-products are abbreviated below:

CCH=4-Cyanocyclohexene

VCH=4-Vinylcyclohexene

NBR Types A and B were prepared by polymerization of acrylonitrile and butadiene in monochlorobenzene as organic solvent, in accordance with the examples of WO 2012/028503 A, with tert-dodecyl mercaptan used as molar-mass regulator.

NBR Type C was prepared by polymerization of acrylonitrile and butadiene in monochlorobenzene as organic solvent, in accordance with the examples of WO 2011/032832 A, with DoPAT (dodecylpropanoic trithiocarbonate) used as molar-mass regulator.

The molar mass was determined in the form of the weight-average molar mass (M_{w}) by means of gel permeation chromatography (GPC) in accordance with DIN 55672-1 (Part 1: Tetrahydrofuran THF as solvent).

### Example 1

A 7.6% strength by weight solution of NBR Type A in monochlorobenzene was used.

The solution of this nitrile rubber was purified batchwise by ultrafiltration. The original solution and also, analogously, the retentate obtained with each overpassage was pumped in circulation under pressure through the membrane module. The desired amount of permeate was separated off and replaced by an equal amount of monochlorobenzene, which was supplied continuously to the retentate. This ensured that there was no change in the concentration of the nitrile rubber in the solution during the purification procedure. In front of the membrane a feed pressure of 10 bar was set. The flow rate of the retentate stream was 2.5 m/s. The differential pressure at the membrane was 1.5 bar, and the permeate flow was 24 kg/m² h. The temperature of the nitrile rubber solution was 90° C.

The membrane module used was a module from atech innovations gmbh, Gladbeck, containing I multi-channel element with a length of 1 m. This multi-channel element contained 7 channels each with an internal diameter of 6 mm and with a membrane area of 0.133 m². The cut-off of the membrane was 5 nm.

The results of the ultrafiltration are indicated in Table 2 below, where the diafiltration coefficient corresponds to the number of passages over the ultrafiltration membrane.

TABLE 2
Results of Example 1

| | Test 1 | Test 2 | Test 3 | Test 4 | Test 5 | Test 6 | Test 7 | Test 8 |
|---|---|---|---|---|---|---|---|---|
| Diafiltration | 0* | 1 | 2 | 3 | 4 | 5 | 6 | 7 |
| coefficient | | | | | | | | |
| CCH [% by weight] | 112.37 | 40.92 | 21.32 | 7.37 | 3.03 | 1.32 | 0.53 | 0.39 |
| based on NBR A | | | | | | | | |
| VCH [% by weight] | 1.26 | 0.43 | 0.20 | 0.05 | 0.01 | <0.01 | <0.01 | <0.01 |
| based on NBR A | | | | | | | | |
| (CCH + VCH) [% by | 113.63 | 41.36 | 21.51 | 7.42 | 3.04 | 1.32 | 0.53 | 0.39 |
| weight] | | | | | | | | |
| based on NBR A | | | | | | | | |

*Start of test

### Example 2

A 5.9% strength by weight solution of NBR Type B in monochlorobenzene was used.

The solution of this nitrile rubber was purified in the same way as in the procedure described in Example 1, on a larger piloting plant. The membrane module used was, again, from atech innovations gmbh. Gladbeck, this time containing 3 multi-channel elements in parallel, each with a length of 1 m. Each multi-channel element contained 7 channels each with an internal diameter of 6 mm and with a membrane area of 0.133 m². The membrane module thus possessed an overall membrane area of 0.399 m². The cut-off of the membrane was 5 nm, and the parameters set were as follows: The flow rate of the retentate stream was 5.4 m/s. The differential pressure at the membrane was 2.8 bar, and the permeate flow was 26.5 kg/m² h. The temperature of the nitrile rubber solution was 31° C.

The results of the ultrafiltration are indicated in Table 3 below.

TABLE 3
Results of Example 2

| | Test 1 | Test 2 | Test 3 | Test 4 | Test 5 |
|---|---|---|---|---|---|
| Diafiltration | 0* | 1 | 2 | 3 | 4 |
| coefficient | | | | | |
| CCH [% by weight] | 38.98 | 14.24 | 5.59 | 2.20 | 1.02 |
| based on NBR B | | | | | |
| VCH [% by weight] | 0.61 | 0.22 | 0.07 | 0.02 | <0.02 |
| based on NBR B | | | | | |
| (CCH + VCH) | 39.59 | 14.46 | 5.66 | 2.22 | 1.02 |
| [% by weight] | | | | | |
| based on NBR B | | | | | |

### Example 3

A 5.2% strength by weight solution of NBR Type C in monochlorobenzene was used.

The solution of this nitrile rubber was purified as described in Example 2, with the following parameters being set: The flow rate of the retentate stream was 4.8 m/s. The differential pressure at the membrane was 3.5 bar, and the permeate flow was 25.3 kg/m²h. The temperature of the nitrile rubber solution was 25° C.

The results of the ultrafiltration are indicated in Table 4 below.

TABLE 4
Results of Example 3

| | Test 1 | Test 2 | Test 3 | Test 4 | Test 5 |
|---|---|---|---|---|---|
| Diafiltration | 0* | 1 | 2 | 3 | 4 |
| coefficient | | | | | |
| CCH [% by weight] | 46.35 | 17.12 | 6.54 | 2.31 | 0.19 |
| based on NBR C | | | | | |
| VCH [% by weight] | 0.48 | 0.17 | 0.06 | 0.02 | <0.02 |
| based on NBR C | | | | | |
| (CCH + VCB) | 46.83 | 17.29 | 6.60 | 2.33 | 0.19 |
| [% by weight] | | | | | |
| based on NBR C | | | | | |

What is claimed is:

1. Process for producing a purified nitrile rubber, characterized in that a nitrile rubber which has repeat units of at least one conjugated diene monomer and of at least one α,β-unsaturated nitrile monomer and also comprises Diels-Alder by-products of these monomers is subjected to an ultrafiltration, by the nitrile rubber, in solution in at least one organic solvent, being passed one or more times over an ultrafiltration membrane, to give a retentate stream which comprises the purified nitrile rubber and does not flow through the ultrafiltration membrane, and a permeate stream which comprises Diels-Alder by-products and which flows through the ultrafiltration membrane, with the provisos that
(i) the ultrafiltration membrane has one or more porous layers and the layer with the smallest pores possesses a pore diameter in the 1-200 nm range,
(ii) the ultrafiltration is carried out at a temperature in the range from 10 to 150° C. with application of a pressure in the range from 1 to 80 bar, and
(iii) the flow rate of the retentate stream during the ultrafiltration is set to a level of greater than 0.2 m/sec, and
the amount of Diels-Alder by-products in the purified nitrile rubber is reduced by at least 50% by weight as a result of the ultrafiltration, relative to the amount in the nitrile rubber originally used.

2. Process according to claim 1, characterized in that the amount of Diels-Alder by-products in the purified nitrile rubber is reduced by at least 80% by weight, preferably by at least 90% by weight and up to 99.9% by weight, based on the amount in the nitrile rubber originally used.

3. Process according to claim 1, characterized in that the nitrile rubber originally used in the ultrafiltration has an amount of Diels-Alder by-products of the monomers in the range from 0.1 to 120% by weight, based on 100% by weight of the nitrile rubber.

4. Process according to claim 1, 2 or 3, wherein the nitrile rubber used has repeat units of at least one conjugated diene selected from the group consisting of 1,3-butadiene, 1,2-butadiene, isoprene, 2,3-dimethylbutadiene, piperylene and mixtures thereof and of at least one α,β-unsaturated nitrile monomer selected from the group consisting of acrylonitrile, methacrylonitrile, ethacrylonitrile and mixtures thereof.

5. Process according to claim 4, wherein the nitrile rubber used has repeat units of acrylonitrile and 1,3-butadiene.

6. Process according to claim 4 or 5, wherein the nitrile rubber used additionally has repeat units of one or more other copolymerizable termonomers, preferably of carboxy-containing, copolymerizable termonomers, more preferably α,β-unsaturated monocarboxylic acids, their esters, their amides, α,β-unsaturated dicarboxylic acids, their mono- or diesters, their corresponding anhydrides or amides.

7. Process according to claim 1, wherein the nitrile rubber used is produced by free-radical polymerization of the corresponding monomers in at least one organic solvent, preferably in dimethylacetamide, monochlorobenzene, toluene, ethyl acetate, 1,4-dioxane, t-butanol, isobutyronitrile, 3-propanone, dimethyl carbonate, 4-methylbutan-2-one, acetone, acetonitrile or methyl ethyl ketone.

8. Process according to claim 7, wherein the free-radical polymerization is carried out
(1) in the presence of a compound of the general structural formula (VI) 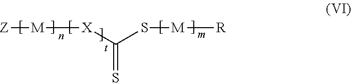
in which
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, silyloxy, nitrile, carbonyl, carboxy, oxycarbonyl, oxysulphonyl, oxo, thioxo, borates, selenates, epoxy, cyanates, thiocyanates, isocyanates, thioisocyanates and isocyanides,
R (a) if m≠0, has the same meanings as the moiety Z and
(b) if m=0, is H, a linear or branched, saturated, or mono- or polyunsaturated alkyl aryl, heteroaryl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, poly-carbonates, polyurethanes, polyisocyanates, polysaccharides, polyesters and polyamides,
n and m are identical or different and are respectively in the range from 0 to 10 000,
t is 0 or 1, insofar as n=0, and is 1 insofar as n≠0, and
X is C(Z₂), N(Z), P(Z), P(═O)(Z), O, S, S(═O) or S(═O)₂, where Z in these moieties can have the meanings stated previously for the formula (VI),
or
(2) in the presence of a compound selected from the group consisting of
(i) mercaptans which comprise at least one SH group,
(ii) mercapto alcohols which comprise at least one SH group and at least one OH group,
(iii) mercaptocarboxylic acids which comprise at least one SH group and at least one carboxy group, and mercaptocarboxylic esters which comprise at least one SH group and at least one carboxylic ester group,
(iv) thiocarboxylic acids,
(v) disulphides, polysulphides,
(vi) thiourea,
(vii) allyl compounds,
(viii) aldehydes,
(ix) aliphatic halohydrocarbons, araliphatic halohydrocarbons and
(x) saccharin and
(xi) any desired mixtures of two or more of the abovementioned molar-mass regulators (i)-(x),
or
(3) in the absence of the compounds recited in sections (1) and (2)(i) to (xi).

9. Process according to any of claims 1 to 8, wherein the organic solvent is selected from the group consisting of aromatic, aliphatic and chlorinated solvents and also ketones and cyclic ethers, more preferably from the group consisting of dimethylacetamide, ethyl acetate, 1,4-dioxane, acetonitrile, tert-butanol, tert-butyl nitrile, dimethyl carbonate, methyl acetate, isobutyronitrile, acetone, toluene, benzene, chlorobenzene, chloroform, methylene chloride, methyl ethyl ketone, tetrahydrofuran and mixtures of two or more of these solvents.

10. Process according to any of claims 1 to 9, wherein the ultrafiltration is carried out at a temperature in the range from 20° C. to 130° C. and at a pressure in the range from 2 bar to 50 bar.

11. Process according to any of claims 1 to 10, wherein the ultrafiltration is carried out at a flow rate of the retentate stream past the membrane in the range from 1 to 10 m/sec, more preferably 2 to 10 m/sec.

12. Process according to any of claims 1 to 11, wherein the layer of the ultrafiltration membrane having the smallest pores possesses a pore diameter in the 1-200 nm range, preferably 1 to 100 nm and more preferably in the range from 1 to 50 nm.

13. Nitrile rubber obtainable by the process according to any of claims 1 to 12.

14. Nitrile rubber according to claim 13 obtainable by the process according to claim 8, comprising
(i) repeat units derived from at least one conjugated diene, from at least one α,β-unsaturated nitrile and optionally from one or more other copolymerizable monomers and
(ii) one or more structural elements of the general formulae (I), (II), (III), (IV) or (V) 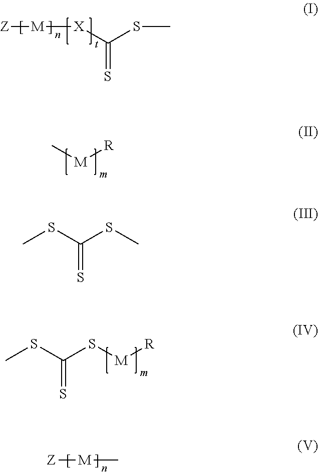
where
Z is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, hydroxyimino, carbamoyl, alkoxycarbonyl, F, Cl, Br, I, hydroxy, phosphonato, phosphinato, alkylthio, arylthio, sulphanyl, thiocarboxy, sulphinyl, sulphono, sulphino, sulpheno, sulphonic acids, sulphamoyl, silyl, silyloxy, nitrile, carbonyl, carboxy, oxycarbonyl, oxysulphonyl, oxo, thioxo, borates, selenates, epoxy, cyanates, thiocyanates, isocyanates, thioisocyanates and isocyanides,
M is repeat units of one or more mono- or polyunsaturated monomers, comprising conjugated or non-conjugated dienes, alkynes and vinyl compounds, or is a structural element which derives from polymers comprising polyethers, in particular polyalkylene glycol ethers and polyalkylene oxides, polysiloxanes, polyols, polycarbonates, polyurethanes, polyisocyanates, polysaccharides, polyesters and polyamides,
n and m are identical or different and are respectively in the range from 0 to 10 000,
t is 0 or 1, insofar as n=0, and is 1 insofar as n≠0,
X is C(Z₂), N(Z), P(Z), P(═O)(Z), O, S, S(═O) or S(═O)₂, where Z in these moieties can have the same meanings as stated previously and
R (a) if m≠0, can have the same meanings as the moiety Z and
(b) if m=0, is H, a linear or branched, saturated, or mono- or polyunsaturated alkyl moiety, a saturated, or mono- or polyunsaturated carbo- or heterocyclyl moiety, aryl, heteroaryl, arylalkyl, heteroarylalkyl, alkoxy, aryloxy, heteroaryloxy, amino, amido, carbamoyl, alkoxy, aryloxy, alkylthio, arylthio, sulphanyl, thiocarboxy, sulphinyl, sulphono, sulphino, sulpheno, sulphonic acids, sulphamoyl, carbonyl, carboxy, oxycarbonyl, oxysulphonyl, oxo, thioxo, epoxy, cyanates, thiocyanates, isocyanates, thioisocyanates or isocyanides.

15. Process for producing vulcanizates by vulcanizing the nitrile rubber according to claim 13 or 14.

16. Vulcanizates based on a nitrile rubber according to claim 13 or 14.
